(19) United States
(12) Patent Application Publication
(10) Pub. No.: US 2003/0018495 A1
(43) Pub. Date: Jan. 23, 2003

(54) System and method for medical drug prescription acquisition

(76) Inventor: Lester Sussman, Bethesda, MD (US)

Correspondence Address: LESTER SUSSMAN, 9213 BULLS RUN PARKWAY, BETHESDA, MD, 20817-2403, US

(21) Appl. No.: 09/902,400

(22) Filed: Jul. 11, 2001

(51) Int. Cl. G06F 17/60

(52) U.S. Cl. 705/2

(57) ABSTRACT

The current invention addresses the problems that are encountered by patients, medical doctors, pharmacies and health insurance companies relating to filling medical prescriptions and related services. These services include, but are not limited to: scheduling appointments with the doctor electronically through the Internet; filing and paying for a medical prescription online through the Internet; electronic notification of any events related to medical issues, e.g. change in the doctor's appointments, availability of prescriptions for pickup, etc.; doctor's online access to the patient's preferred drug list as specified by the patient's PBM and Health Insurance plan; the pharmacy's electronic receipt and confirmation of a patient's prescription via the Internet; the patient's electronic notification of the readiness of a filled prescription; and the simplifying the refilling of medical prescriptions.

### BACKGROUND OF THE INVENTION

The current invention addresses the problems that are encountered by patients, medical doctors (MDs), pharmacies and health insurance companies relating to filling medical prescriptions. The method avails it itself to be used in other ways, some of which will be discussed in this invention.

More than 44% of Americans take prescription drugs daily (source: USA Today, Jan. 31, 2001). MDs handwriting is notoriously illegible, so much so that according to the Institute of Medicine, in 1999 these errors cost $77 billion annually and cause 7,000 deaths a year. Legally, these misinterpreted MDs' prescriptions have resulted in 90,000 malpractice claims over a recent 7-year period. Pharmacists mitigate these risks by calling the MDs for clarification of the prescriptions. These calls amount to 30% of the prescriptions that pass through pharmacists' hands. In call volume this is about 100 million phone calls a year (Source: “A Plan to Send Prescriptions Electronically ”, The New York Times, Feb. 23, 2001).

Next follows a description of the average process that a consumer, i.e. patient currently undergoes to acquire prescribed medication. A patient, to obtain a prescription for medication from an MD, follows the following steps as described in Table 1:

TABLE 1

| Step | Patient Task Description |
|---|---|
| 1. | Schedule an appointment with the MD. |
| 2. | Go to the MD's office for the scheduled |
| | appointment. |
| 3. | Be examined and diagnosed by the MD. |
| 4. | The MD writes out and signs a prescription for the |
| | patient. |
| 5. | The patient takes the prescription to his pharmacy |
| | to be filled. |
| 6. | The patient provides Health Insurance information |
| | to the pharmacist. |
| 7. | The patient has a choice to wait for the filled |
| | prescription, or to return later. |
| 8. | Once the prescription has been filled, the patient |
| | pays for it. |

A pharmacist, to fill a prescription for medication from a patient, follows the following steps as described in Table 2:

TABLE 2

| Step | Pharmacist Task Description |
|---|---|
| 1. | Read the patient's prescription. |
| 2. | If any problems occur in understanding the |
| | prescription, call the doctor's office for |
| | clarification. |
| 3. | Verify the patient's Health Insurance. |
| 4. | Verify the patient's Health Insurance coverage for |
| | the prescribed medication. |
| 5. | Fill the prescription. |
| 6. | Hand over the filled prescription to the waiting |
| | patient. |
| 7. | Accept payment for the filled prescription. |

Note that the MD invariably is unaware which medications are covered by the patient's Health Insurance. This information is usually only confirmed at the pharmacy in Table 1, Step [4]. If the prescribed medication is not covered by the patient's Health Insurance, then the pharmacist must call the MD, who can fax or give the pharmacist a new prescription over the phone. Furthermore, if the medication is on the FDA's list of Schedule 4 or 5 drugs, a new written prescription must be obtained, i.e. the patient must return to the doctor's office and pick up a new prescription. Furthermore, the MD may have to consult with the patient whether or not another replacement medication could have allergic effects, etc.

Today many employers and insurers hire drug plan managers, i.e. pharmacy benefit managers (PBMs). PBMs create lists of preferred drugs for plan members, which are generally the least expensive drugs. This system works by the pharmacy contacting the PBM to verify the doctor's prescribed medication. If the MD's prescribed drug is not on the PBM list, the pharmacy needs to contact the MD for a possible alternative, i.e. Step [2] in Table 2. Examples of PBMs are AdvancePCS, Express Scripts and Merck-Medco. These three companies have over 125 million members who used half of the 2.5 billion prescriptions filled in 2000.

Recently the three major PBMs in the US, as mentioned above, formed a joint venture called RxHub. The proposed method and system of RxHub is to provide electronic filing of prescriptions between MDs, pharmacies and PBMs. An article in The New York Times, Feb. 23, 2001 titled “A Plan to Send Prescriptions Electronically” succinctly describes this system and hence is not described in detail here. The problem with this system and method is that the patient is still left on the sidelines, although the benefits to the patient are excellent. This invention addresses the inclusion of the patient in the acquisition of an electronically filed medical prescription.

With the Internet boom, many proposals have appeared in various media regarding the entry of doctors into the computer age. Today only 5% to 10% of the US's 750,000 doctors use computer systems other than for billing systems, i.e. very few doctors use patient email interaction, online appointment scheduling, electronic filing of prescriptions, etc. (Source: “Physicians Are Entering the Computer Age”, The Wall Street Journal, Aug. 28, 2000). This patent addresses these online patient medical services. WebMD is one company that is tackling these challenges as well as others. The Internet boom has borne the arrival of online drugstores, e.g. VitalRx.com, Walgreens.com, etc. Even these pharmacists require patients to mail prescriptions to them and to verify the prescription with the MD by telephone (Source: “How to Tell Whether That Online Drugstore Is Really a Good Deal”, The Wall Street Journal, Feb. 16, 2001). The present invention addresses these manual interactions.

There are numerous other patents that address computerizing various aspects of the medical profession. For example, U.S. Pat. No. 5,832,447 by Rieker et al. teaches a system and method to verify a patient's health insurance eligibility. U.S. Pat. No. 4,858,121 by Barber et al. teaches a method to coordinate and pay the relevant parties in a medical transaction. U.S. Pat. No. 5,301,105 by Cummings, Jr. teaches a comprehensive health care system. None of these mentioned patents fully address the problems that are encountered by patients, medical doctors, pharmacies and health insurance companies relating to filling medical prescriptions, that the present invention addresses.

### OBJECTIVES OF THE PRESENT INVENTION

The objective is to provide the medical patient with an array of convenient and easy to use services when interacting with his medical doctor (MD) and related services. These services include, but are not limited to:

Scheduling an appointment with the MD electronically through the Internet.

A choice of interacting with the MD electronically.

Filing and paying for a prescription online through the Internet.

Being electronically notified of any events related to medical issues, e.g. change in doctor's appointments, availability of prescriptions for pickup, etc.

MD's online access to the patient's preferred drug list as specified by the patient's PBM and Health Insurance plan.

Pharmacists' electronic receipt and confirmation of a patient's prescription.

Patient electronic notification of the readiness of a filled prescription.

Simplifying the refilling of medical prescriptions.

### BRIEF DESCRIPTION OF THE DRAWINGS

FIG. 1 is a schematic of the preferred invention's embodiment of the patient's medical online experience.

FIG. 2 is a schematic of the preferred invention's embodiment of the patient's medical online experience's processes.

### DETAILED DESCRIPTION OF THE INVENTION

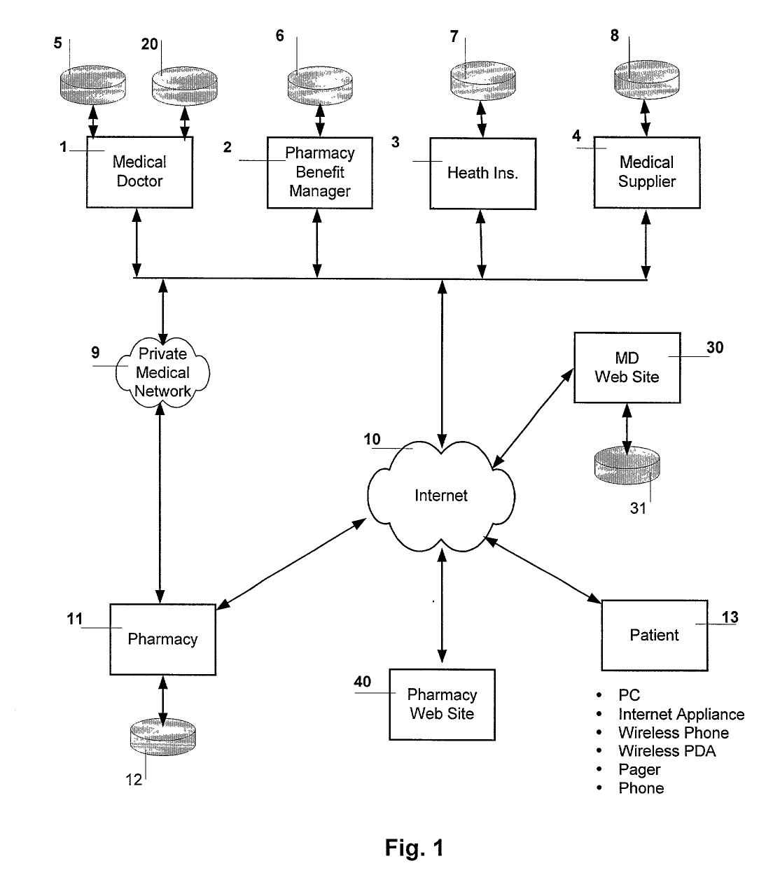

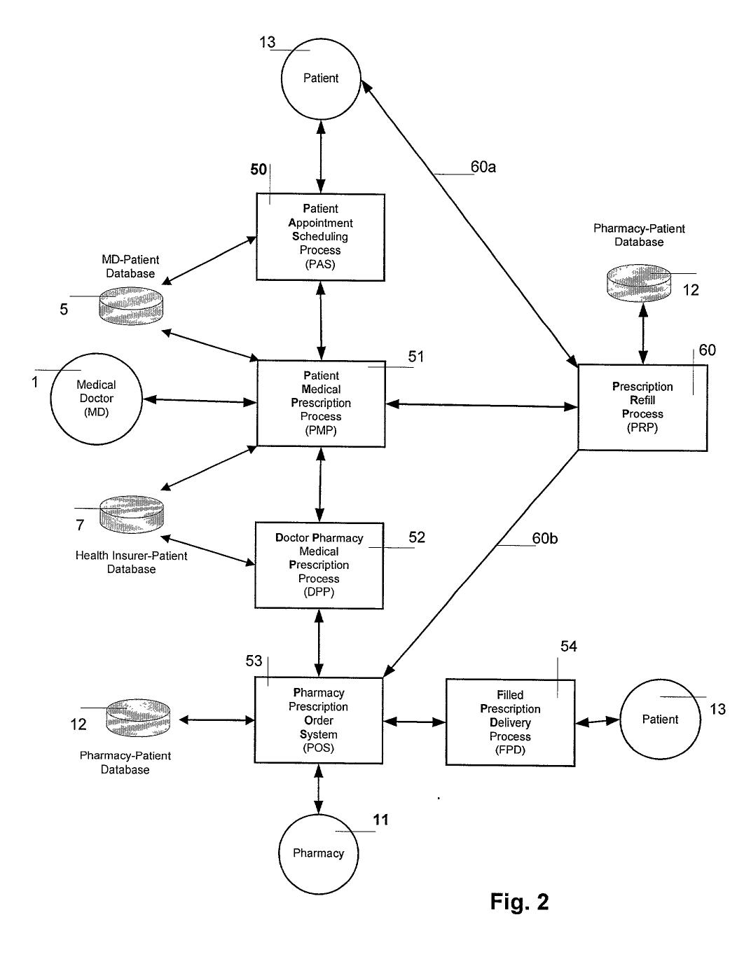

With reference to FIG. 1 and FIG. 2, a Medical Doctor 1, a Pharmacy Benefit Manager 2 (PMB), a patient's Health Insurer 3, a patient's Pharmacy 11 and a Medical Supplier 4 connect with one another by means of a Private Medical Network 9 and/or the Internet 10. Today the communication link via a Private Medical Network 9 is fairly common amongst most of the service providers, whereas the Internet 10 communications is not common. In addition to these various medical service providers inter-connectivity, the Patient 13 is connected as well to the various service providers via the Internet 10.

Using encryption technology such as Secure Sockets Layer (SSL) and Public Key Infrastructure (PKI), secure communication between all participants via the Internet 10 is used in this invention's preferred embodiment. Furthermore, information stored on the various participants' databases is encrypted as well. The reason for using this encryption technology is to ensure patient confidentiality, specifically in compliance with the US Health Insurance Portability And Accountability Act of 1996 (HIPAA). The invention's preferred embodiment uses available standards for encryption such as Phil Zimmerman's Pretty Good Privacy (PGP), OpenPGP (the IETF's RFC 2440) and other available PKI encryption standards.

Examples of the various participants' databases includes the patient's medical records database 5 at the Medical Doctor 1; the patient's Health Insurance database 6 at the PMB; the patient's medical record database 7 at the Health Insurer 3; the supply database 8 for a Medical Doctor 1 at the Medical Supplier 4 and the patient's database 12 at the Pharmacy 11. These databases are discussed are more detail later in the invention's preferred embodiment.

Before continuing with the description of the preferred embodiment, an overview of various cryptography technologies that are used by the preferred embodiment are now discussed.

Cryptography for Verification, Integrity and Confidentiality

Two key technologies that the preferred embodiment of the invention uses is public key and conventional cryptography to ensure three things:

(1) The transaction partner (e.g. Medical Doctor 1, Pharmacy 11, Health Insurer 3, Patient 12, etc.) is who he claims to be.

(2) Confidentiality of the data transmitted between the transaction partners.

(3) The data has not been altered during transmission.

Various implementations of cryptography are used in the invention's preferred embodiment, such as Netscape's Secure Socket Layer (SSL), Phil Zimmerman's Pretty Good Privacy (PGP), Microsoft's Secure Electronic Transactions (SET), etc. All of these methods use a combination of public key and conventional cryptography.

Conventional cryptography is also called secret key or symmetric key cryptography. The Data Encryption Standard (DES), Triple Des and Message Digest 5 (MD5) are examples of symmetric key cryptography. MD5 is described in further detail in the Internet Engineering Task Force's (IETF) RFC 1321. Use of secret keys to encrypt data is much faster than public key encryption, but the problem of using symmetric keys is the safe distribution of the keys between transaction partners. This key distribution is solved using public key cryptography.

Public key cryptography is an asymmetric method that uses a pair of keys for encryption: a public key that encrypts data and a private key (i.e. secret key) that decrypts the data. The public key is openly distributed. The key's owner keeps the private key secret. The secret key cannot readily be derived from the public key.

The above methods of cryptography are not described in detail in this invention. Excellent references are available that were used to devise the preferred embodiment of the invention. These references include:

“An Introduction to Cryptography” by Network Associates, Inc.

“How SSL Works” by Netscape.

“Internet Cryptography” by Richard E. Smith.

“Applied Cryptography” by Bruce Schneier.

The Internet Engineering Task Force RFC library.

A brief description follows of the various cryptography implementations that the invention's preferred embodiment uses.

PGP uses a combination of public-key and conventional encryption to provide security services for electronic mail messages and data files. These services include confidentiality and digital signature. The IETF has a number of RFCs on PGP, which is also known as OpenPGP, e.g. RFC 1991 (“PGP Message Exchange Formats”) and RFC 2440 (“Open Message Format”).

Some background on PGP now follows. When plaintext is encrypted with PGP, PGP first compresses the plaintext. Data compression saves data transmission time and device memory space and, more importantly, strengthens cryptographic security. Most cryptanalysis techniques exploit patterns found in the plaintext to decode the cipher. Compression reduces these patterns in the plaintext, thereby greatly enhancing resistance to cryptanalysis. PGP then creates a session key, which is a one-time-only secret key. This key is a random number generated from the random movements, e.g. of a computer's mouse and the keystrokes that are typed. This session key works with a very secure, fast conventional encryption algorithm to encrypt the plaintext; the result is ciphertext. Once the data is encrypted, the session key is then encrypted to the recipient's public key. This public key-encrypted session key is transmitted along with the ciphertext to the recipient.

Decryption works in the reverse. The recipient's copy of PGP uses her private key to recover the temporary session key, which PGP then uses to decrypt the conventionally encrypted ciphertext.

The combination of the two encryption methods combines the convenience of public key encryption with the speed of conventional encryption. Conventional encryption is about a thousand times faster than public key encryption. Public key encryption in turn provides a solution to key distribution and data transmission issues. Used together, performance and key distributions are improved without any sacrifice in security.

A cryptographic key is a value that works with a cryptographic algorithm to produce a specific ciphertext. Keys are basically very large numbers. Key size is measured in bits; the number representing a 1024-bit key is computationally very large. In public key cryptography, the bigger the key, the more secure the ciphertext. However, public key size and conventional cryptography's secret key size are totally unrelated. A conventional 80-bit key has the equivalent strength of a 1024-bit public key. A conventional 128-bit key is equivalent to a 3000-bit public key. Again, the bigger the key, the more secure, but the algorithms used for each type of cryptography are very different. While the public and private keys are mathematically related, it's very difficult to derive the private key given only the public key; however, deriving the private key is always possible given enough time and computing power. This makes it very important to pick keys of the right size; large enough to be secure, but small enough to be applied fairly quickly. Larger keys will be cryptographically secure for a longer period of time. Keys are stored in encrypted form. PGP stores the keys in two files on the user's computing device (see Table 4): one for public keys and one for private keys. These files are called keyrings. If the private keyring is lost, the user will be unable to decrypt any information encrypted to keys on that ring. As with any user generated electronic file, it is advisable for the user to back up these PGP keyrings to floppy disk, Zip disk, or any other appropriate electronic media.

The invention's preferred embodiment uses PGP to create digital certificates. Digital certificates (certificates) allow the recipient of information to verify the authenticity of the information's origin. In other words, digital certificates provide authentication and data integrity. Non-repudiation is also provided. A digital certificate consists of three components:

A public key

Certificate information, e.g. patient's name, patient's logon user ID, patient's

address, etc.

One or more digital signatures.

The purpose of a digital signature on a certificate is to attest that the certificate information has been electronically notarized by some other person or entity, e.g. from a trusted third party such as a Certificate Authority, e.g. VeriSign. The digital signature does not validate the authenticity of the whole certificate; it only vouches that the signed identity information goes along with the public key. PGP uses a one-way hash function to create a digital signature. Valid hash functions used in the IETF's OpenPGP include MD2, MD5, SHA-1 and RIPEMD-160. PGP uses a hash function on the certificate information that is being signed. This generates a fixed length data item known as a message digest. Any alteration to the certificate information results in a totally different message digest (digest), i.e. data integrity is established. PGP then uses the message digest and the private key to create the digital signature. Upon receipt of the certificate, the recipient uses PGP to re-compute the message digest, thus verifying the signature. As long as a secure hash function is used, there is no way to take someone's signature from one document and attach it to another, or to alter a signed message in any way. The slightest change in a signed document will cause the digital signature verification process to fail.

In June 2000 the US Congress passed an act (the Electronic Signatures in Global and National Commerce Act) to legally accept digital signatures in electronic transactions. In July 2000 President Clinton signed the Electronic Signatures in Global and National Commerce Act.

The preferred embodiment uses various trusted parties to create digital certificates. Various formats exist for digital certificates including PGP and the International Telecommunications Union's (ITU) X.509 certificates. The preferred embodiment of the invention uses PGP certificates, but could easily use X.509 certificates, or other certificate formats. The format of a PGP certificate is as follows:

The PGP version number—identifies which version of PGP was used to create

the key associated with the certificate.

The certificate holder's public key—public portion of the holder's asymmetric

key pair together with the algorithm of the key: RSA, Diffie-Hellman, or

DSA.

The certificate holder's information—e.g. Patient 13 name, Patient 13 logon

user ID, Patient 13 address, etc.

The digital signature of the certificate owner—uses the private key of the

certificate holder's public key.

The certificate's validity period—start date and expiration date.

The preferred symmetric key method for the key—e.g. Triple-DES, CAST, or

IDEA.

SSL has been universally accepted on the Internet 10 for authenticated and encrypted communication between clients and servers. Considering the Open Systems Interconnection (OSI) model, the SSL protocol runs above TCP/IP (transport layer, i.e. layer 4 in the OSI model) and below higher-level protocols such as HTTP or SMTP (presentation and application layers, i.e. layers 6 and 7 in the OSI model). SSL runs in the session layer, layer 5 in the OSI model. It uses TCP/IP on behalf of the higher-level protocols, and in the process allows an SSL-enabled server to authenticate itself to an SSL-enabled client, allows the client to authenticate itself to the server, and allows both machines to establish an encrypted connection. These capabilities address fundamental concerns about secure communication over the Internet 10 and other TCP/IP networks such as the Private Medical Network 9:

SSL server authentication allows a user to confirm a server's identity. SSL-enabled client software running on a computing device can use standard techniques of public-key cryptography to check that a server's certificate and public ID are valid and have been issued by a certificate authority (CA) listed in the client's list of trusted CAs.

SSL client authentication allows a server (e.g. the MD Web Site 30, etc.) to confirm a user's identity. Using the same techniques as those used for server authentication, SSL-enabled server software can check that a client's certificate and public ID are valid and have been issued by a certificate authority listed in the server's list of trusted CAs.

An encrypted SSL connection requires all information sent between a client and a server to be encrypted by the sending software and decrypted by the receiving software, thus providing a high degree of confidentiality. Confidentiality is important for both parties to any private transaction. In addition, all data sent over an encrypted SSL connection is protected with a mechanism for detecting tampering, that is for automatically determining whether the data has been altered in transit.

The SSL protocol includes two sub-protocols: the SSL record protocol and the SSL handshake protocol. The SSL record protocol defines the format used to transmit data. The SSL handshake protocol involves using the SSL record protocol to exchange a series of messages between an SSL-enabled server and an SSL-enabled client when they first establish an SSL connection. This exchange of messages is designed to facilitate the following actions:

Authenticate the server to the client.

Allow the client and server to select the cryptographic algorithms, or ciphers, that they both support.

Optionally authenticate the client to the server.

Use public-key encryption techniques to generate shared secrets.

Establish an encrypted SSL connection.

For more details on SSL, the Netscape web site provides a wealth of information at http://developer.netscape.com/docs/manuals/security.

TLS (Transport Layer Security) is a new and evolving Internet Engineering Task Force (IETF) standard and is based on SSL. TLS is defined in RFC 2818 (“HTTP Over TLS”). This invention does not exclude the use of TLS in place of SSL when TLS is adopted on the Internet 10.

Using PKI, each of the medical participants is assigned a digital certificate and a digital signature. Information contained in the digital certificate includes the provider's name, address, phone number(s) and other identifying information. When communicating with the relevant recipient party, this digital certificate is encrypted with the recipient's public key. Sometimes the recipient does not need to be privy to information contained in the certificate, for example the patient's social security number (SSN). Using a similar method outlined in U.S. Pat. No. 5,790,677 by Fox et al, this information is encrypted with the public key of the final recipient. For example, the patient's SSN may be needed when the Pharmacy 11 verifies the patient's information with the Health Insurer 3. The patient's SSN would be encrypted with the Health Insurer's public key and not the Pharmacy's public key. Hence only the Health Insurer 3 would be able to decrypt and read this information.

Before describing any of the processes in detail, note that the preferred embodiment of the invention uses the current state of the art of human-computer-interface (HCI) technology. For example computer systems interact with a person by means of a graphical user interface (i.e. a GUI), which is implemented in a programming language such as C++, Java or C#. Currently computer access control is by means of password or a pass phrase, although the use of biometrics is increasing. The conventional HCI today is by means of a keyboard, a pointing device (e.g. a mouse, touch-screen, etc.) and a monitor. HCI by means of voice recognition, e.g. from Dragon Systems Inc., is available today, but is not easy to use to replace the conventional HCI, but the current invention does not exclude use of this type of HCI technology.

We now consider the invention's preferred embodiment in implementing the average process that a Patient 13 undertakes to obtain and fill a medical prescription, as detailed in Tables 1 and 2.

Patient Appointment Scheduling Process (PAS 50)

The Patient 13 connects to the Internet 10 using his computing device, e.g. a PC, or Wireless Phone, or Wireless Personal Digital Assistant (PDA such as the Palm or Handspring), etc. These computing devices as described in more detail in Table 4. The Patient 13 connects to the web site 30 of his Medical Doctor 1. A service provider such as WebMD, an Internet Service Provider (ISP) such as America Online, MSN, etc. could host this web site 30, or it could be hosted on a computer at the Medical Doctor's office. Once connected to the doctor's scheduling web site, the patient logs on. All information transmitted between the Patient 13 and the Medical Doctor 1 is encrypted, e.g. by means of SSL and authenticated using his password or pass-phrase. Ideally the patient's computing device would transmit his issued doctor's digital certificate as described in the '677 patent. Alternatively using standard computer security methodologies, the Patient 13 provides his name and other private information, e.g. his Social Security Number's last four digits and his home ZIP code when logging on. This information is transmitted using SSL and is verified in the doctor's patient database 5. After verification, the Patient 13 is presented with a menu of options, including the means to schedule an appointment. Today many companies provide the means to view and schedule appointments via the Internet 10. Examples include Yahoo! Calendar (calendar.yahoo.com/), iPlanet's Calendar Server product, etc.

The Patient 13 is presented with available appointment times for his doctor 1 via a GUI, either web based or client software based using a language such as Java or C#. The preferred embodiment uses a web based calendaring system. The doctor's appointment schedule is kept in a database 31 at the MD Web Site 30, as well as at her medical office in the master schedule database 20. The scheduling calendar system automatically retrieves the relevant doctor's schedule based on information obtained by looking up the patient's doctor on record in the patient database 5. Note that it is fairly common for doctors to have multiple offices within her practice, e.g. for discussion purposes, let us consider two medical offices. Hence a patient could schedule an appointment in either of the doctor's medical offices. Typically, both doctor's offices would have their own patient scheduling database 5. This invention implements a snap shot (i.e. patient to doctor relationship) of this database 5 at the MD Web Site 30. In the case of multiple doctor's offices, the web site 30 snapshot merges the two scheduling databases. Furthermore, usually there is more than one Medical Doctor 1 in a doctor's office and hence the doctor's patient database 5 knows which doctor 1 that the Patient 13 uses. The Patient 13 selects an appropriate date and time for an appointment and where appropriate, the relevant office location as well.

Note that the doctor's displayed schedule contains information on her complete schedule, including vacations, conferences, etc. The related dates are simply made unavailable. No detailed information is revealed to the Patient 13, e.g. whether or not an unavailable date is because the doctor 1 is on vacation, or because her schedule is full seeing other patients. All that the Patient 13 needs to know is on what dates and times he can see the doctor 1.

The PAS 50 GUI then presents the Patient 13 with a choice of how he wishes to be contacted for confirmation of the appointment, as well as in the event that the appointment needs to be rescheduled. The Patient 13 can enter his work, home, etc. email address; his work, home, etc. phone number; his pager number; his cell phone number, etc. The patient record database 5 contains the default method of contact and automatically displays this choice in the pick list to the Patient 13. When scheduling the appointment the Patient 13 is prompted to enter information regarding the nature of the appointment, e.g. annual check-up, frequent headaches, etc. The PAS 50 system allows the Patient 13 to download the scheduled appointment into his personal information manager's calendar, i.e. into Microsoft Outlook on a PC, the Date Book on a Palm, etc. Various computer data synchronization techniques are available today including the Palm-PC HotSynch Manager from 3COM and the Bluetooth wireless technology. After the Patient 13 has completed setting up his doctor's appointment, he logs off from the doctor's web site 30.

In the doctor's office, a staff member usually consults the doctor's appointments. A number of various options are possible in implementing this step. For example, the staff member could log onto the doctor's scheduling web site 30 and review all scheduled appointments. This method requires that there is a reliable connection from the Medical Doctor 1 to the Internet 10. Unfortunately today this is not always the case. Alternatively the preferred embodiment of the invention has implemented a distributed database system. This method has the doctor's scheduling web site 30 exchange new information with the doctor's master scheduling database 20 located at the doctor's office. Hence, a consistently reliable Internet 10 connection is not necessary. The invention's preferred embodiment has implemented a pull method, i.e. a computer at the doctor's office logs onto the Internet 10, or via the Private Medical Networks 9, and checks for any new scheduling information. This pull step could be scheduled to be triggered by time, e.g. every 30 minutes, or the doctor's scheduling web site 30 could send, e.g. via email, an encrypted message to the doctor's master scheduling database 20 computer that new scheduling information is available for downloading. Alternatively, the doctor's scheduling web site 30 could simply push new information to the doctor's scheduling database 20 computer. Once the doctor's staff has the latest information she can send a verification notice to the Patient 13. The invention's preferred embodiment's verification methodology has the medical staff member checking off the scheduled appointment on the PAS 50 system and the system sends the relevant verification message to the Patient 13. Patient requested verification messages sent via email or to a pager are fairly common today. On the other hand if the Patient 13 has requested that a message is to be called into a phone number, the preferred embodiment's doctor's computer generates a digital voice message that is transmitted over the dialed phone number. The tried and tested fail-safe method of a doctor's staff member picking up the phone and calling the Patient 13 is always available. There are occasions when the Medical Doctor 1 needs to reschedule the patient's appointment. All the doctor 1 needs to do is modify the patient's appointment in his scheduling database. The system would then send a message via the patient's preferred verification method. The patient appointment scheduling process (PAS 50) as described above would then be repeated.

TABLE 3
Patient Messaging

| Notification | |
|---|---|
| Method | Description |
| 1. Email | Electronic mail (email) message to is sent to the Patient's |
| | registered email address. Today email would be primarily |
| | received at home or at work on a computing device (see |
| | Table 4). |
| 2. Wireless | This is a wireless phone with Internet capabilities, such as |
| SmartPhone | accessing web pages, email, etc. Current examples include |
| | the Kyocera QCP 6035 and the Samsung SPH-I300. |
| 3. Wireless | Standard wireless phone using the standard technologies of |
| Phone | the day, e.g. GSM, CDMA, TDMA, etc. Both voice |
| | messages and these cell phones can receive text messages. |
| 4. Pager | Today pagers can receive numeric and/or text messages. |
| | The preferred embodiment uses text pagers to contact |
| | patients. Examples of pagers include various Motorola |
| | devices such as the PF 1500, T350 and the CP1250. |
| 5. Phone- | Many people have answering machines at home and at the |
| voice | office. A voice message can consequently be left on the |
| message | relevant device. |
| 6. Phone- | Manual messages can be called in as well, i.e. person-to- |
| manual | person, rather than to a computing device. |

TABLE 4
Computing Devices

| Computing | |
|---|---|
| Device | Description |
| PC | Personal Computer, e.g. Microsoft |
| | Windows, Apple, Linux, etc. |
| PDA | Personal Digital Assistant, e.g. the Palm, |
| | the Handspring, the Revo from Psion, etc. |
| | Communications for a PDA is via a |
| | docking station connected to a PC, or via a |
| | wireless modem or phone. PDA's can |
| | connect to a Local Area Network via |
| | wireless, e.g. using the 802.11b or |
| | Bluetooth communications. |
| Wireless | Technology continues to evolve wireless |
| Phone | phone into the capability of accessing |
| | computer based information systems. For |
| | example, the Motorola i85s can run certain |
| | Java applets. These devices are also |
| | generically known as Smart Phones. |
| Internet | The devices are specific for accessing the |
| Appliance | Internet, i.e. not being able to run the |
| | normal slew of PC programs. Examples of |
| | these devices include the Audrey from |
| | 3COM, the iPAQ from Compaq, etc. |

Patient Medical Prescription Process (PMP 51)

This process begins with the Patient 13 meeting with his Medical Doctor 1 at the scheduled date and time as determined during PAS 50. When the doctor 1 is ready to write out a prescription for the Patient 13, she would access the patient's medical record database 5 on her computer, or some other electronic device that can access this database 5 (e.g. a wireless PDA, Tablet PC, etc. using wireless LAN technology such as 802.11b, Bluetooth, etc.). The doctor 1 is presented with a choice of medications that are available to the Patient 13 through his Health Insurer 3 or related PBM 2. Today this information is rarely available to a Medical Doctor 1 when prescribing medication for a Patient 13 and is usually only available at the Pharmacist 11, who contacts the PBM 2, if one is provided by the patient's health plan. If for example, the patient's Health Insurer 3 does not cover the doctor's preferred medication, then this medication would not be selectable by the doctor 1, but will be visually available with a pertinent note. Furthermore, because the patient's health insurance plan coverage is available to the doctor 1, she can quickly tell whether or not any necessary medical procedures are covered by the patient's Health Insurer 3 and hence can make an informed and timely decision for the treatment of the Patient 13.

A master list of available medications, by Health Insurer 3 plan and where maintained by the Pharmacy Benefit Manager 2, is kept in the doctor's patient database 5. As in the case of the appointment schedules, the preferred embodiment implements a distributed database scheme. In this implementation, the Health Insurer 3 database 7 sends plan information to the Medical Doctor's patient database 5 either via the Private Medical Network 9 or via the Internet 10. The reason that the preferred embodiment uses this implementation is once again to reduce the risk that the doctor's and the Health Insurer's Internet connections could be unavailable at the moment the doctor needs the relevant information. A note about the Pharmacy Benefit Manager's (PBM) interaction, rather than having to electronically interact with another service provider, the preferred embodiment has the PBM's medication's database 6 synchronize with the Health Insurer's medication database 7. Hence the Medical Doctor 1 only needs to synchronize with the Health Insurer's database 7; both for the patients' health plan coverage and covered medications. On the other hand, to those versed in the art, it is obvious that direct interaction between the Medical.Doctor's database 5 and the PBM's database 6 is feasible as well.

For reliable Internet connections, the doctor 1 could simply log on to the Health Insurer's patient database 7 via the Internet 10, or via the Private Medical Network 9, using SSL or a Virtual Private Medical Network (VPN). The objective behind the invention is to provide secure, timely and reliable accessibility to needed Patient 13 medical information.

The doctor 1 then inquires from the Patient 13 which Pharmacy 11 he wishes to use to fill the prescription. The doctor 1 selects the relevant Pharmacy 11 from a pick list presented to her on the computer. If the patient's preferred Pharmacy 11 is not on the available pharmacies pick list, the doctor 1 can type the relevant information into the PMP 51 system, which automatically checks to see if the entered Pharmacy 11 subscribes to the Electronic Prescription Filing System (EPFS).

The doctor 1 selects the relevant medication from the medications' option list and selects the “Write Prescription” option on her computer. The doctor's computer and software generates a digital certificate for the relevant pharmacy 11, which includes all the relevant prescription information. PKI prompts the doctor 1 to digitally sign the certificate, which she does by entering a secret pass phrase. Alternatively the digital signature could be based on biometrics, e.g. a fingerprint, or retina-scan. The preferred embodiment implements digital signatures by means of a secret pass phrase. To those versed in the art, it is obvious that biometrics or another scheme could be used to uniquely identify the doctor's authority. Furthermore, as computer human voice recognition evolves into a more usable system, all this information could be entered into the system via voice commands, rather than via a keyboard and mouse. The preferred embodiment uses available human-computer interface technology, i.e. keyboard and mouse. The doctor's PMP 51 system stores a copy of the prescription in the patient database 5 and then transmits the encrypted medical prescription, i.e. prescription digital certificate to the patient's Pharmacy 11, either via the Private Medical Network 9, or via the Internet 10. The prescription has now entered the doctor-pharmacy medical prescription process (DPP 52).

Doctor-Pharmacy Medical Prescription Process (DPP 52)

The prescription order message format between the doctor 1 and the Pharmacy 11 could be an email (e.g. formatted in the Extensible Markup Language [XML] standard), a direct connect to the pharmacy's prescription order database 12, or web site. Because Internet email is currently a relay system and there is no guarantee of timely delivery, the preferred embodiment implements this step as a direct, secure connection to the pharmacy's prescription order web server. The doctor's PMP 51 system automatically and securely logs on to the pharmacy's web server using it's authorized pharmacy logon, e.g. via SSL. Once the Pharmacy 11 has verified the doctor's PMP 51 system's access, it receives the new prescription order and places it in its database 12. The prescription order has now entered the pharmacy's prescription order system (POS 53).

Pharmacy Prescription Order System (POS 53)

The pharmacy's prescription order system (POS 53) electronically verifies the following information:

TABLE 5

| Step | Verification Process |
|---|---|
| 1 | The Medical Doctor's digital certificate information, including, but |
| | not limited to the doctor's digital signature, medical practitioner |
| | ID, contact address and phone number, etc. |
| 2 | The patient's Heath Insurer 3 ID, the patient's pharmacy database 6 |
| | record, address, contact information, etc. |
| 3 | The availability and Heath Insurer 3 coverage for the patient's |
| | prescribed medications(s). |
| 4 | If the Patient 13 chose to pay by credit card, the patient's credit |
| | card information is verified. The patient's credit card information |
| | can be entered at the doctor's office, prior to transmission of the |
| | electronic prescription. Alternatively, the patient's credit card |
| | information could be on record in the pharmacy's patient database |
| | 12. |

Once the POS 53 has verified all of the above information, i.e. Steps (1) through (4) in Table 5, the pharmacist is notified on his computing device (see Table 4 for examples) to fill the new prescription order.

On the other the hand, if a problem arises during the verification process, the pharmacist is notified of the problem on his computing device in order to resolve the problem. A more sophisticated implementation of the POS 53, electronically contacts the relevant party of the discovered problem. For example, if the doctor's PMP 51 system were not able to verify that the prescribed medication was covered by the patient's Health Insurer 3, and the Pharmacy 11 POS 53 was able to confirm that the medication is not covered for the Patient 13, then this status would be relayed back to the Medical Doctor 1. Preferably, this relaying of information would be done through the doctor's PAS 50 system, or via encrypted email to comply with patient privacy and HIPAA. The Medical Doctor 1 can then take the appropriate action, i.e. possibly returning to the PMP 51 and PAS 50 systems.

Filled Prescription Delivery (FPD 54)

Once the Pharmacy 11 has filled the prescription order, the pharmacist checks off the prescription order status in the POS 53. The POS 53 then checks to see how the Patient 13 requested to obtain the prescription, e.g. the Patient 13 may have requested that the prescription be:

(a) Delivered to his home or place of work,

(b) Made available at the pharmacist's drive-through facility, or

(c) Contacted for collection at the pharmacy's pickup desk.

In the case (a) for delivery, the POS 53 securely forwards the relevant information to the pharmacy's shipping department. The shipping department could be the pharmacist's online web facility, for example such as CVS's online prescription web site at ww.cvs.com/promotion/rxeasy.

In the case (b) where the Patient 13 will pick up the filled prescription from the pharmacy's drive-through facility, the P0S 53 securely forwards the relevant information to the Pharmacy 11 packing department.

In the case (c) where the Patient 13 will pickup the filled prescription from the Pharmacy 13, the POS 53 contacts the Patient 13 by means of how the Patient 13 requested notification for a filled prescription. Examples of this notification means includes, email (to a patient's home, cell phone, pager, wireless PDA, etc.), a message to a paging system, a voice message to a phone number, etc.

A note about other possible features of the POS 53, in the invention's preferred embodiment the system prints the relevant prescription's bottle's label and other pertinent information for the Patient 13, e.g. medication instructions, side effects, etc.

Prescription Refill Process (PRP 60)

Often a medical prescription is not filled in total the first time that the Pharmacy 11 receives a prescription order. Prescription refills are part of the order. Sometimes the Medical Doctor 1 has approved a certain number of refills. On the other hand, the refills may have run out and the Patient 13 may continue to need prescribed medication. Both of these prescription refill scenarios are now discussed.

(a) Prescription Refills Available:

In the case where the prescription has a certain number of refills, say four for example, and then the pharmacy's patient database 12 has a record of this information. When the Patient 13 needs to obtain a refill on his prescription, the invention's PRP 60 offers a number of methods to fill the prescription refill.

In the first case, the medication is taken on a fixed time schedule and hence the pharmacy's patient database 12 can predict when the Patient 13 will need a refill. In this case the PRP 60 system can execute any of the following scenarios, as requested by the Patient 13:

1. A refill notification 60a is sent to the Patient 13. Refer to Table 3 for the various patient notification options. When the Patient 13 receives the notification 60a, he responds to either fill the prescription or not to fill the prescription. If the notification message is electronic, the preferred embodiment provides a simple interface that automatically accesses the Pharmacy Web Site 40 when the Patient 13 responds. For example, email messages can be sent and received in HTML (Internet Hypertext Markup Language) format and hence the relevant URL (Internet Universal Resource Locator) can be embedded in the email's responses. If the response is affirmative, then the PRP 60 places the patient's prescription order into the pharmacy's Prescription Order System (POS 53).

2. Automatic refill requests that do not require any verification by the Patient 13. In this scenario the PRP 60 automatically places 60b the patient's prescription order into the pharmacy's Prescription Order System (POS 53). The Patient 13 is sent notification (see Table 3) that his prescription is being refilled.

The POS 53 (see above detailed description) processes the refill order and then forwards the filled prescription to the pharmacy's Filled Prescription Delivery (FPD 54, see the above section for a more detailed description) system in order to get the refill to the Patient 13.

In the second case, where the pharmacy's database 12 cannot predict when the patient's prescription will run out, the Patient 13 initiates the PRP 60. In this case the Patient 13 securely logs on to the pharmacy's prescription web site 40 using his computing device (see Table 4). Note that even though in FIG. 1 the pharmacy's prescription web site 40 is shown to be separate from the Pharmacy 11, the current invention does not exclude the possibility that both the Pharmacy 11 and the pharmacy's prescription web site 40 are co-located for Internet 10 access. Once the Patient 13 has been authenticated, he selects the option to order a prescription refill. The PRP 60 system securely, e.g. using SSL, displays all relevant information to the patient, including whether or not the Patient 13 wishes to pay for the refill online. When the Patient 13 is done with ordering his prescription refill, he logs off of the pharmacy's prescription web site 40. In this second case the PRP 60 system places the patient's prescription order into the pharmacy's Prescription Order System (POS 53). The POS 53 (see above detailed description) processes the refill order and then forwards the filled prescription to the pharmacy's Filled Prescription Delivery (FPD 54) system in order to get the refill to the Patient 13.

To those versed in the art, it is obvious that it is possible for the Patient 13 to securely log on to the pharmacy's patient database 12 and access the pharmacy's Prescription Order System (POS 53) directly without having to go via the pharmacy's prescription web site 40. The invention's preferred embodiment provides access to the POS 53 via the pharmacy's prescription web site 40, but does not exclude an implementation involving direct, secure POS 53 access via the Internet 10.

(b) Prescription Refills Unavailable:

In this scenario, the Patient 13 needs to contact his Medical Doctor 1, who then needs to initiate the PRP 60. The preferred embodiment has the Patient 13 securely logging on to the MD Web Site 30. Once authenticated, the Patient 13 selects the “Refill Prescription” that the PAS 50 system displays to him. The PAS 50 system forwards the patient's request the doctor's patient database 5. Refer to the section on PAS 50 for a more detailed description of this process.

The doctor's patient database 5 notifies the Medical Doctor 1 that her Patient 13 has requested a prescription refill. A number of options are available to the doctor 1:

1. The Medical Doctor 1 can deny the request.

2. The Medical Doctor 1 can approve the request.

3. The Medical Doctor 1 can schedule to discuss the request with the Patient 13.

In the first case i.e. a denial of the request, the PMP 51 system sends a notification (see Table 3) to the Patient 13. In the second case the prescription refill order is forwarded to the DPP 52 system and the Patient 13 is notified (see Table 3). In the third case the Patient 13 is notified (see Table 3) to either contact the doctor 1, or to schedule an appointment to see the doctor 1.

Other Uses of the Invention

Even though the invention's preferred embodiment does not discuss other uses in detail, it is obvious to one versed in the art what a secure, trusted and easy to use medical patient system can offer, besides that which is described in detail above. A quick review of one of these applications is now discussed:

Medical Supplies:

Today the doctor's medical assistant orders supplies through a catalog, which is mailed the medical office. There are different suppliers for different items. For example, medical supplies like instruments are ordered from a surgical supplier over the fax. Other supplies are ordered sometimes from local vendors over the telephone. This includes items such as Betadine, cotton swabs, paper products. Using the invention's preferred embodiment, the medical assistant would receive either copy of the Medical Supplier's 4 catalog, which is stored on the disk drive at the medical office's computer, or the medical assistant would connect to the Medical Supplier's 4 web site to browse the catalog online. The medical assistant then places an order for the required medical supplies either via the Medical Supplier 4 web site, or by means of an email sent to the Medical Supplier 4. As described above in Cryptography for Verification, Integrity and Confidentiality, the supply order request would be encrypted appropriately. Payment for the medical supplies could be included in the order by using a digital certificate bearing appropriate credit card information, or the Medical Doctor's 1 account with the Medical Supplier 4 could be billed.

What is claimed:

1. A medical drug prescription health care management system comprising:
(a) input means for entering data identifying each of a predetermined plurality of persons;
(b) a data memory interconnected with said input means, said data memory including an identification of predetermined medical prescription drugs requiring utilization review;
(c) payment means;
(d) means in communication with said input means responsive to input of data through said input means symbolic of prescription drugs of one of said predetermined plurality of persons for a proposed mode of treatment for said one of said predetermined plurality of persons and, when said proposed mode of treatment includes one of said predetermined prescription drugs requiring utilization review, for producing indicia indicative thereof and for preventing selection therefore until said utilization review has been obtained and data indicative thereof has been entered in said system; and
(e) said predetermined plurality of persons are patients of medical doctors.

2. A medical drug prescription health care management system according to claim 1 in which said input means to input data is a computer, a personal digital assistant, a wireless telephone with input means and an Internet Appliance.

3. A medical drug prescription health care management system according to claim 1 in which said means of communication is the Internet Protocol.

4. A medical drug prescription health care management system according to claim 1 in which said payment means is credit card payment means.

5. A medical drug prescription health care management system according to claim 1 in which said prescription drug utilization review is determined by said patient's health insurance provider.

6. A medical drug prescription health care management system comprising:
(a) input means for entering data identifying each of a predetermined plurality of persons;
(b) a data memory interconnected with said input means, said data memory including an identification of said plurality of persons requiring medical attention (patient) by a medical doctor;
(c) said predetermined plurality of persons are patients of medical doctors;
(d) payment means;
(e) input means for scheduling an appointment between said patient and said medical doctor such that said patient need not directly interact with staff at said doctor's medical office;
(f) means to store said scheduled of appointments in a data memory; and
(g) means to notify said patient of said scheduled appointment with said doctor and any changes thereof.

7. A medical drug prescription health care management system according to claim 7 in which said input means for scheduling an appointment is the World Wide Web.

8. A medical drug prescription health care management system according to claim 7 in which said means of notification is sending an electronic-mail message, or a simple-mail message to a wireless telephone, or a pager message, or a voice-mail message to a telephone mailbox, or a manual interaction with said patient.

9. A medical drug prescription health care management system comprising:
(a) input means for entering data identifying each of a predetermined plurality of persons;
(b) a data memory interconnected with said input means, said data memory including an identification of said plurality of persons requiring medical attention by a medical doctor;
(c) said plurality of persons requiring medical attention are patients of said medical doctors;
(d) payment means;
(e) means in communication with said input means responsive to input of data through said input means symbolic of prescription drugs of one of said predetermined plurality of persons for a proposed mode of treatment for said one of said predetermined plurality of persons and, when said proposed mode of treatment includes one of said predetermined prescription drugs requiring utilization review, for producing indicia indicative thereof and for selecting said prescription drug, or plurality thereof for said patient use;
(f) means to communicate said selected prescription drug, or plurality thereof to a pharmacy to fill prescription order for said patient;
(g) means to notify said patient of said prescription's fill status with said pharmacy and any changes thereof;
(h) means to obtain said pharmacy filled prescription by said patient; and
(i) means to refill said medical drug prescription.

10. A medical drug prescription health care management system according to claim 9 in which said means to communicate said selected prescription drug to a pharmacy is by means of the World Wide Web.

11. A medical drug prescription health care management system according to claim 9 in which said means to communicate said selected prescription drug to a pharmacy is by means of direction interaction with the pharmacy's order entry database system.

12. A medical drug prescription health care management system according to claim 9 in which said means of notification is sending an electronic-mail message, or a simple-mail message to a wireless telephone, or a pager message, or a voice-mail message to a telephone mailbox, or a manual interaction with said patient.

13. A medical drug prescription health care management system according to claim 9 in which said means to obtain pharmacy filled prescription by said patient is delivery means, or pick-up from the pharmacy counter, or pick-up from the pharmacy drive-through means.

14. A medical drug prescription health care management system according to claim 9 in which said refill means is by means of a database automatic timed reminder means when said prescription is about to become depleted.

15. A medical drug prescription health care management system according to claim 9 in which said refill means is by means of said patient placing a refill order for said prescription drugs by means of the Internet.
